(19) United States
(12) Patent Application Publication
(10) Pub. No.: US 2022/0332386 A1
(43) Pub. Date: Oct. 20, 2022

(54) SAFETY APPARATUS WITH SENSORY ALERTS TO SURROUNDING PERSONS

(71) Applicants: Saxon Eldridge, Lebanon, NJ (US); Shem Lachhman, Ponce, PR (US); Jermaine Tai, Brooklyn, NY (US); Jeffrey Ting Yun Ng, Brookyln, NY (US)

(72) Inventors: Saxon Eldridge, Lebanon, NJ (US); Shem Lachhman, Ponce, PR (US); Jermaine Tai, Brooklyn, NY (US); Jeffrey Ting Yun Ng, Brookyln, NY (US)

(21) Appl. No.: 17/714,232

(22) Filed: Apr. 6, 2022

Related U.S. Application Data
(60) Provisional application No. 63/176,389, filed on Apr. 19, 2021.

(51) Int. Cl. B62J 45/422; G07C 5/08; B62J 50/21; H04W 4/029; H04W 4/80; B60W 50/14

(52) U.S. Cl. CPC B62J 45/422; G07C 5/0816; B62J 50/225; H04W 4/029; H04W 4/80; B60W 50/14; B60W 2050/146

(57) ABSTRACT

The invention relates to a super slim, form fitting, rechargeable and detachable safety device that spans the length of a bicycles, four wheeler, motorcycle, or scooters handlebars that cars and people cannot miss, day or night. It features an adaptable and flexible structure that conforms to the shape and length of one man, two, or four wheeled vehicles or body shapes. Instant invention can utilize sound, lighting or other sensory alerts to notify pedestrians and motorists of the presence of the motorist using it and also features connectivity for data exchange

### COPYRIGHT STATEMENT

A portion of the disclosure of this patent document contains material that is subject to copyright protection. The copyright owner has no objection to the facsimile reproduction by anyone of the patent document or the patent disclosure as it appears in the Patent and Trademark Office patent file or records, but otherwise reserves all copyright rights whatsoever.

Trademarks used in the disclosure of the invention and the applicants make no claim to any trademarks referenced.

### CROSS-REFERENCE TO RELATED APPLICATIONS

This application claims the benefit of U.S. Provisional Patent Application No. 63/176,389, filed on Apr. 19, 2021 which is incorporated by reference herein in its entirety.

### BACKGROUND OF THE INVENTION

### 1) Field of the Invention

The invention relates to the field of safety devices, and, more particularly to a form fitting safety device for bicycles, four wheelers, motorcycles, strollers, or scooter's that alert pedestrians to the presence of the rider and user.

### 2) Description of Related Art

Safety of motorists on public roads is a large concern for urban and often over populated cities. In several cities across the world, using alternative means of transportation from automobiles is preferred as the cost is much lower toward the rider. Unfortunately, safety for the riders is greatly reduced on two wheeled and four wheeled open roof vehicles as there is no protective chassis that automobiles provides to its conductors and riders. Currently the state of the art includes safety lights and reflectors, safety systems and sensor based protective devices which can be divided into a number of discrete categories. These included: Sensor based systems and alerting devices such as lights that the rider wears, sensor based systems and alerts that are attached to the alternative transportation methods, alert systems and devices that the rider wears and alerts that are attached to the transport means.

The issue with the current state of the art is its inability to increase awareness of the rider in all environmental states. Whether it be during rain, sleet, light fog, heavy flow, snow precipitation, low traffic patterns, high traffic patterns, and differing sunlight conditions. All of these conditions govern a pedestrian's or automobile driver's ability to see what is around them and what is immediately in front of them. In these differing conditions, whether it be different precipitation or various conditions on the road is where the current state of the art does not adapt to provide the optimal alerts to pedestrians that are around a motorist. Most safety devices such as lights are limited in their display and operate on the principle of: greater lumens create greater visibility. The issue is that in most cases, small form factor lights with high lumens are still overlooked by motorists and still cause accidents as these safety devices are unable to adapt to the surrounding environment. For instance, higher lumen lights when in raining conditions or fog decreases visibility for the rider as it is reflected off the fog and rain droplets. Additionally, the current prior art contains rectangular or circular form factors which do not provide conductors of vehicles in oncoming traffic the information necessary and early enough to understand what is approaching their direction, thus decreasing the safety of bicycle, scooter, four wheeler, and other alternative transports. The prior art is replete with lights that show different strobes and modes for alerting surrounding passers but become limited in urban and even less crowded areas as they are unable to adapt to the most optimal alerting solution to surrounding pedestrians and motorists.

However, there is a need for a safety device that can adapt its sensory alerts to nearby pedestrians and motorists according to the current environmental situation.

In particular, there is a need for a comprehensive system that can detect differing traffic, weather, and environmental changes and vary the sequence, or frequency of sensory alerts to surrounding pedestrians about the presence of the user. While the user is also alerted to pedestrians and other vehicles via the same sensory alerts.

### BRIEF SUMMARY OF THE INVENTION

The instant invention in one form is directed to a super slim, form fitting, rechargeable and detachable safety device that spans the length of a bicycles, four wheelers, ATV's, motorcycles, or a scooter's handlebars that cars and people cannot miss, day or night. The safety device of the instant invention operates on the principle of adapting its sensory alerts to the surrounding environment in order to create greater awareness of the user. It features an adaptable and flexible structure that conforms to the shape and length of one man, two, or four wheeled vehicles, and also fashion accessories.

Instant invention can utilize sound, lighting or other sensory alerts to notify pedestrians and motorists of the presence of the motorist using it and also features connectivity for data exchange between smart devices and instant invention to facilitate health, and traffic monitoring and alerts.

An advantage of the present invention is the ability to detect differing traffic, weather, and environmental changes and vary the sequence, or frequency of sensory alerts to surrounding pedestrians about the presence of the user. The structure of the instant invention's housing allows for an interchangeable unit that can be mounted onto a bicycle, chest of a user, backpack, and even canine companion. The instant invention also features connectivity to a user interface which uses the GPS coordinates of local businesses. Local businesses can sign up to the user interface and offer promotions to regular commuters who travel along the route of the local businesses.

### BRIEF DESCRIPTION OF THE DRAWINGS

A further understanding of the nature and advantages of particular embodiments may be realized by reference to the remaining portions of the specification and the drawings, in which like reference numerals are used to refer to similar components. When reference is made to a reference numeral without specification to an existing sub-label, it is intended to refer to all such multiple similar components.

FIG. 1 is a drawing of the integrated version of the instant invention;

FIG. 2 shows an adaptive and flexible version able to conform to the shape of differing two, three, or four wheeled vehicles of the instant invention;

FIG. 3 shows detailed components of the safety device in a detachable version of the invention including camera, sensors, and sensory alert devices;

FIG. 4 shows the instant invention with swappable sensory alert devices in a unified package;

FIG. 5 shows the instant invention with separate data hub for capturing environmental data with cameras, sensors, inertial sensors, and sensory alert devices;

FIG. 6 shows the various components such as the integrated battery, on/off switch, and wiring of the instant invention, and sensor alert devices;

FIG. 7 shows a functional diagram of the instant invention to select the optimal sensory alert for raising awareness to nearby pedestrians of the users presence based on the sensor readings;

FIG. 8 shows a functional diagram of the instant invention to select the optimal sensory alert for raising awareness to nearby pedestrians of the users presence based on a wireless devices reading and communication to the safety device;

FIG. 9 shows a functional diagram of the system to award the traveler with promotions from 3^{rd} party vendors that are along repeated traveled routes by the user;

FIG. 10 shows a functional diagram of the system architecture to earn currency as the user utilizes the instant invention;

FIG. 11 shows a functional diagram of the verification process to ensure the user has used the instant invention in order to gain earnings from a local, cryptocurrency or virtual currency;

FIG. 12 shows a functional diagram of the instant invention able to communicate with other instant invention devices on a network, and exchange data from a central server to the instant invention;

FIG. 13 is a functional diagram of the instant invention to detect accidents and change sensory triggers to surrounding pedestrians and alert the emergency contacts of the user;

FIG. 14 is a functional diagram of the instant invention to detect incidents of accidents and also incorporate a kill switch to deactivate any sensory alerts from be sent to emergency contacts;

FIG. 15 is a functional diagram of the instant invention to detect user controls from conformal switches built into the instant invention;

FIG. 16 is a functional diagram of the instant invention to manually control differing sensory alerts of the instant invention as a result of differing rider actions;

FIG. 17 is a diagram of the instant invention to be adapted from differing use cases such as a backpack, bicycle handlebar, helmet or stroller;

FIG. 18 is a diagram of the instant invention to record, process, and transfer data to a cloud server, distributed ledger technology, or data base via wireless transmission methods;

FIG. 19 is a diagram of the instant invention graphical user interface run on a smart device;

FIG. 20 is a diagram of the instant invention where safety device of the instant invention is mounted to bicycle.

Corresponding reference characters indicate corresponding parts throughout the several views. The exemplifications set out herein illustrate embodiments of the invention and such exemplifications are not to be construed as limiting the scope of the invention in any manner.

### DETAILED DESCRIPTION

While various aspects and features of certain embodiments have been summarized above, the following detailed description illustrates a few exemplary embodiments in further detail to enable one skilled in the art to practice such embodiments. The described examples are provided for illustrative purposes and are not intended to limit the scope of the invention.

In the following description, for the purposes of explanation, numerous specific details are set forth in order to provide a thorough understanding of the described embodiments. It will be apparent to one skilled in the art; however, that other embodiments of the present invention may be practiced without some of these specific details. Several embodiments are described herein, and while various features are ascribed to different embodiments, it should be appreciated that the features described with respect to one embodiment may be incorporated with other embodiments as well. By the same token; however, no single feature or features of any described embodiment should be considered essential to every embodiment of the invention, as other embodiments of the invention may omit such features.

In this application the use of the singular includes the plural unless specifically stated otherwise and use of the terms “and” and “or” is equivalent to “and/or,” also referred to as “non-exclusive or” unless otherwise indicated. Moreover, the use of the term “including,” as well as other forms, such as “includes” and “included,” should be considered non-exclusive. Also, terms such as “element” or “component” encompass both elements and components including one unit and elements and components that include more than one unit, unless specifically stated otherwise.

Lastly, the terms “or” and “and/or” as used herein are to be interpreted as inclusive or meaning any one or any combination. Therefore, “A, B or C” or “A, B and/or C” mean “any of the following: A; B; C; A and B; A and C; B and C; A, B and C.” An exception to this definition will occur only when a combination of elements, functions, steps or acts are in some way inherently mutually exclusive.

As this invention is susceptible to embodiments of many different forms, it is intended that the present disclosure be considered as an example of the principles of the invention and not intended to limit the invention to the specific embodiments shown and described.

The terms bicycle, vehicle, four wheeler, all-terrain vehicle, tricycle, motorcycle, and scooters are used interchangeably to mean a vehicle that the instant invention can be attached to mean a vehicle for use with the instant invention

The terms safety device, light, alert and sensor, are used interchangeably to mean a safety device of the instant invention.

The terms smart device, processor, mobile device, processor, microprocessor are used or computer interchangeably to mean a device capable of executing a program of the instant invention.

The prior art does not provide for a system that has the ability to read the local environment and adapt the sensory triggers to increase visualization of the user and capture the attention of local pedestrians and motorists that are around the user.

In one embodiment the instant invention is a safety device which features built-in sensors to detect changes in the environment and as a result adapt the sensory alerts of the instant invention to the surrounding pedestrians that is far and within proximity of the user. While most bike or alternate transportation method safety device(s) focus on projection or reflection of light or the instant invention focuses on increasing visibility and perception of the instant invention's user among the surrounding pedestrians and motorists by utilizing proximity, Infra-Red (IR), and visual sensors to sense the proximity of local pedestrians and emit a sensory trigger to alert all surrounding persons of the proximity of the user of the instant invention and ensure the safety of the main user and surrounding pedestrians. Sensory triggers can also change depending on the traffic pattern, proximity of a motorist or pedestrian, weather and other environmental changes. Changing the sensory triggers allow for higher noticeability of the user and increases safety. The instant invention also incorporates built-in wide angle cameras and sensors such as accelerometers, inertial sensors, gyroscopes, and devices to record daily commutes and record evidence of accidents or incidents which may harm the rider's health. The recording can be used as evidence in insurance claims and police reporting of the incident.

In yet another embodiment a smart device connection via Bluetooth or other wireless communication technologies allows for data exchange between smart devices and the instant invention. However, the inventors realize that the wireless communication protocol can be selected from any wireless technology including Bluetooth, Wi/Fi, Zigbee, Near Field Communications (NFC), LTE, 4G, 5G and other wireless technologies. The information can be health statistics about the rider, traffic patterns on the local roads traveled by the riders, and performance statistics about the rider's speed, pace, distance traveled, or calories burned. In addition, the instant invention can send out alerts to emergency contacts such as family or friends, about the well-being of the main user. If the main user is in an accident, the instant invention will send out an instantaneous emergency communication to ensure emergency contacts know when and where an incident occurred. The instant invention can also change its sensory triggers once an accident has been identified by the system. In many case the motorists are thrown off the bicycle or motorcycle and are unable to reach their cellphone but also are still in danger if they are in the middle of a road in the case of a hit and run. The device can change the sensory triggers such as light, sound, or vibration to an SOS mode which alerts passers of the accident and to avoid the user of the instant invention from being struck a second time. In one embodiment, the device can use the built in accelerometer or sensor to sense if the user was hit or struck.

In another embodiment, the instant invention can connect to a smart device via Bluetooth, Wi/Fi, Zigbee, Ultrawideband, LTE, 4G and 5G or other wireless transmission methods and use the information collected by the smart device's built in sensors to detect if there was an accident or incident to the user of the instant invention. The instant invention may also communicate the incident to other users of the instant invention. Cameras built into the instant invention record the incident to provide evidence for insurance claims or to local law enforcement. Emergency alerts or SOS alerts can be turned on or turned off manually from a control hub or from conformal flex or touch mode sensors. Other controls such as sensory triggers can be controlled from flex or touch mode sensors also in order to satisfy user preference.

In yet another embodiment the instant invention can be integrated with Global Positioning Systems (GPS) over a wireless network to track the frequent paths traveled by users. The instant invention provides a user the ability to receive promotions from local businesses on the routes they frequently travel such as a discount for coffee or laundry services. Several commuters pass the same business each day but are unaware of the type of business, what they offer, and if there are any promotions. Local businesses can sign up to an online registry of the instant invention and upload promotions for a nominal fee as a means of marketing to users of the instant invention. The instant invention provides for a graphical user interface managed by a smart device or computer that allows each local business or user to sign up and input information such as location, address, or demographics.

In yet another embodiment the instant invention can be fitted with unique identifier such as Quick Response code (QR) or barcodes to serve as evidence of membership to the promotional program as the instant invention units can be detached and carried on the person of a user. The promotional code of the instant invention is stored on a cloud, data base, or distributed ledger technology via a graphical user interface run on a smart device of the user.

In yet another embodiment the instant invention provides a native rewards program in which data such as but not limited to miles, or time used of the instant invention can be redeemed by the user of the instant invention. The graphical user interface ran by a smart device or computer in one embodiment of the instant invention can contain and present metrics as to how many awards have been accumulated by the user.

In yet another embodiment, one unit of the instant invention can communicate with another unit of the instant invention to exchange and alert users of the instant invention to weather changes, traffic changes, harmful events, or animal sightings which can also be stored in a remote server, data base, cloud, distributed ledger technology and communicated to smart devices or computers of the users of the instant invention.

In yet another embodiment, the instant invention can also be directly built into the handlebars of bicycles, four wheelers, and motorcycles to allow a safety device which follows the shape and design of a handlebar to increase awareness and communicate the right information sooner to oncoming traffic or pedestrians and also to prevent theft. The prior art contains rectangular or circular form factors which does not provide oncoming traffic early notification of the presence of the user but by attaching the light so that it is linear and proximal to the handlebar it displays the handlebar to oncoming traffic that gives the driver the most information about what they are perceiving in an earlier time period.

In another embodiment, the instant invention is designed with a housing to be interchangeable from a bicycle or two wheeled motor vehicle to a chest, bag, helmet, dog harness attached unit to allow the unit to allow protection during use of a vehicle or while walking.

Additionally, the primary difference between the instant invention and competing products is the ability to read the local environment and adapt the sensory triggers of the instant invention to increase visualization of the user and capture the attention of local pedestrians and motorists that are around the user. The sensory triggers can comprised of light such as LEDs, incandescent lights, halogen lights and other future lighting technology, or sound that change the brightness or frequency of pulse of either.

In yet another embodiment of the instant invention, sensing can occur by two methods: data exchange from a smart device which readily has the information collected, or via sensors built into the instant invention. Data exchange between a smart device and the instant invention can occur from Bluetooth, Wi/Fi, Zigbee, Ultrawideband, NFC, LTE, 4G, 5G or comparable wireless communication technologies. Sensors such as humidity, temperature, an anemometer for wind or precipitation sensing can be used to detect the weather of the local environment. The instant invention additionally incorporates proximity sensors such as IR, or laser sensors to sense the distance of pedestrians, motorists or objects. Cameras mounted on the front, rear and side of the instant invention can also be used for proximity estimation and recording of accidents or instances of theft. Furthermore, in one situation, the traffic of the local roads traveled by the user can be congested with many cars. As a result, the instant invention will adapt or change the frequency, pitch, or intensity of the sensory alerts for other pedestrians or nearby motorists.

In yet another embodiment the instant invention's proximity sensors may notice a driving pattern of a distracted or unfocused motorist that is driving in the direction of the instant invention user at a rapid rate. The instant invention's sensory alerts then rapidly change from a normal state to a state where the driver is alerted to the presence of the user and correct the driving pattern to avoid an accident. The state can encompass loud siren noises, or increasing the intensity and pulsating of light. The instant invention may also illuminate the surrounding areas, such as the ground or nearby wall with a pattern or text that will capture the attention of oncoming traffic and set boundaries of safety for the user. The same change implemented by an onboard computer, processor or microprocessor to the instant invention's triggers can occur for differing types of weather, where heavy rain or snow reflects light with a high radiance and therefore the intensity of light should be lower than the maximum. The instant invention's sensors work to measure the direction and speed of an oncoming car by detecting the light during night time or daytime running lights which are standard on automobiles. The illumination, spread, and distance of the oncoming light is measured via cameras or sensors and processed to change the sensory alerts of the invention to alert the motorist earlier rather than later. The instant invention may also change a sensory alert based on the posted speed limit and the speed of the surrounding motorists. For example, if a motorist drives by the user of the instant invention and exceeds the posted speed limit of the road traveled, the instant invention can alert the driver and other approaching drivers. In order to perform these functions, the instant invention initiates sensing, sensors detect changes in the environment or surroundings, then the data is processed by a processor or microprocessor, and recorded by a smart device running a graphical user interface which then uploads all data to a wireless storage such as a cloud, distributed ledger technology, or data base. The sensor alerts are changed once the data is processed by the processor.

Furthermore, the instant invention can also incorporate lane departure sensors that sense oncoming traffic in the blind spots of the user. The lane departure sensors can be mounted on the handles of bicycles, scooters, kid strollers, ATVs, and four wheeled vehicles. Additionally, each lane departure sensor can also be mounted on the front and rear of runners to create a safer exercise environment and that will help motorists view the user of the instant invention more clearly.

Furthermore, the instant invention also features an emergency alert system where a user's emergency contacts can be alerted if the user were ever in an accident. In several cases, accidents between automobiles and cyclists render the cyclist immobile, or thrown off of their bicycle and unable to contact a loved one or friend for aid or assistance. The system works with directional, speed, yaw, or acceleration sensors to detect if an accident or collision has occurred. The sensors may include an inertial sensor, accelerometer, gyroscope or equivalent sensor. A typical scenario would be that the rider or runner is traveling along a path. Then the instant invention detects the speed, motion, yaw, or acceleration of the user from sensors. Then the instant invention analyzes the data captured from the sensors and either outputs a safe situation or unsafe situation to a processor. Then if a car or other pedestrian collides into the user of the instant invention then the speed or acceleration changes of the user and a collision is detected based on the force received. The change in speed or detection of the collision is then analyzed to ensure it was not a false alarm and categorizes the severity of the accident based on the velocity at the time of impact. If no false alarm is detected, then the instant invention communicates to the user's smart device to send an SOS alert to a designated emergency contacts, or the instant invention's communicates with a smart device to send the alerts over a cellular network or wireless network to a storage, such as a data base, cloud, or distributed ledger technology. If a false alarm is detected, then the instant invention sends a communication alert to the user's smart device asking if the user is coherent. Additionally, the instant invention emergency alert system can also communicate alerts to other instant invention users that are nearby or that have a relationship with the user.

To maximize the safety of the users of the instant invention each device is equipped to communicate with one another or communicate with third party platforms or smart phone apps which will collect and transfer data such as changes in weather, traffic, or dangerous events, obstructions in the road, and the like.

Communication as shown between the instant invention devices can also include sharing performance statistics with other users, recording goals met for charity runs or cycling. In this case the instant invention can be equipped with mobile network connectivity such as analog, LTE, 4G/5G or connect directly to the user's smartphone or wireless communication device.

In another embodiment the instant invention is connected to an online platform run of a smart device which monitors the GPS location of its users. Users such as riders, motorists, local businesses each have differing levels of access. Users such as businesses can upload advertisements and promotions that are exclusive to other instant invention users via a graphical user interface run on a smart device. Most commuters use the same route to run their errands or to commute to their jobs. The instant invention users can then receive promotions from the local businesses if they travel along the same path via a graphical user interface run on a smart device. The instant invention itself can be equipped with a unique ID that is paired with the information of the user and used to redeem promotions or rewards from local merchants. In each local network, which can encompass a city or local township, performance statistics are reported to other users, for exercise competitions. Top performers can receive additional prizes and promotions. Performance can be measured by calories burned, distance traveled, frequency of use, and other health statistics.

The instant invention may include an interactive graphical user interface which displays the collected health, performance, environmental, safety and other future relevant information. The graphical user interface can be used to receive user inputs to control the many functions of the instant invention. The graphic user interface can be a screen mounted onto the frame of a bicycle, or other vehicles, or a runner or walker's body. The graphical user interface can be embedded into the user's handlebars frame. The instant invention's graphic user interface can include a suite which reads the behaviors of the user and riding performance to output informational tips on better riding habits for increased exercise performance, or longevity and decreased wear and tear of vehicle parts. Information such as frequent braking, hard stops, hitting bumps, hard acceleration which can hurt the knees or a bike, scooter, or vehicle's drive system.

The instant invention can also be equipped with additional features that are built into the instant invention physical unit such as a direction sensory alert via a sensor which detects a change in direction. As a result, a left or right signal is triggered which alerts surrounding persons of the direction of the turn. The sensor can also detect periods of slowed pace or riding to trigger a rear sensory alert. The rear sensory alert can have two states where in the normal state the sensory alert is in a passive or sleep mode and then when the sensor detects the slowed pace, the sensory alert changes states to alert other surrounding pedestrians and motorists whether the user of the instant invention is turning left or turning right or stopping.

The instant invention housing can also be equipped inductive charging base unit, quick release mount system, swappable sensory alerts and power units, integrated controls momentary switch. The instant invention can also incorporate controls implemented by user inputs which change the blinking patterns or modes. Blinking patterns can be changed to pulse at certain rhythms, or with certain colors depending on the local environment. The system can also utilize a processor or microprocessor with wireless connection as the controller.

In yet another embodiment, the graphical user interface run by a smart device of the instant invention comprises of an artificial intelligence which learns and optimizes information such as the route traveled by the user, pace of the user and energy spent, or time traveled by the user. In one embodiment, the artificial intelligence may receive inputs from local traffic light patterns. The traffic light pattern able to be assessed where the artificial intelligence recognizes how many red lights and green lights are along a particular route and determines the optimal pace of the user so as to decrease the energy spent and travel time of the user. In another embodiment, the instant invention artificial intelligence may analyze the health statistics of a user and output optimal pace, or speed for the user to travel. In another embodiment the artificial intelligence may analyze the heart rate or blood pressure of the user and determine that the user is expending too much energy to arrive at a destination.

In yet another embodiment, the instant invention may take the form of a fence post cap to alert drivers of the presence of the fence or that they are traveling too fast along a road.

In yet another embodiment the instant invention can be a lighting fixture for use in outdoor settings where pedestrians, or motorists are alerted to the presence of a building, light post, or fixture along the side of a road. The instant invention serves the dual purpose of also illuminating a road for higher visibility by sensing the local environment and changing the sensory alerts based on the data collected from the local environment.

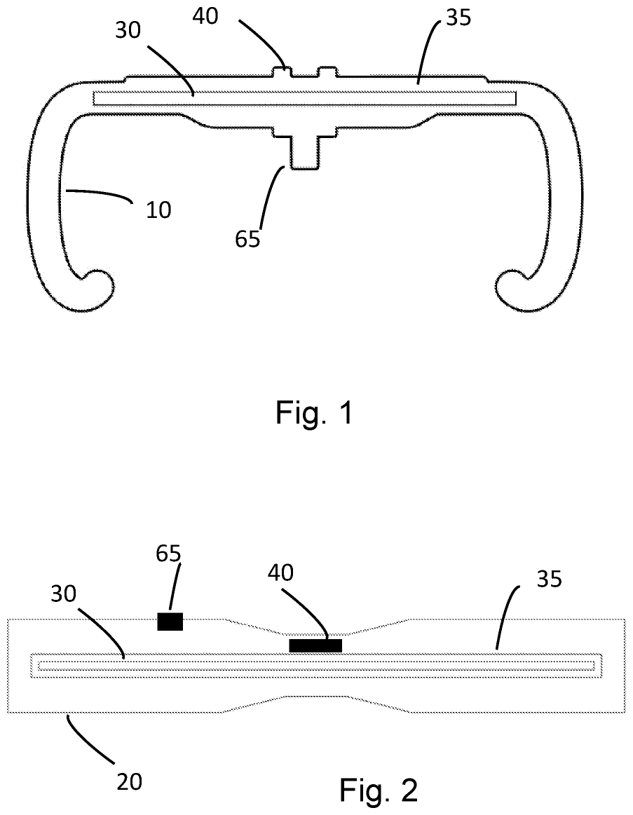

Referring now to the drawings, and more particularly to FIG. 1, there is shown a drawing of the handlebar 10 of the instant invention with integrated touch sensor 40, battery housing 65 and right LED strip 35 and left LED strip 30.

FIG. 2 shows an adaptive and flexible embodiment of the handle bar attachment 20 of the instant invention able to conform to the shape of differing two, three, or four wheeled vehicles. The handle bar attachment 20 being made of flexible material and held to the handle bar of the vehicle by clips, straps, tie wraps, zip ties, hooks, clasps, Velcro or other fastening method can adapt to any shape or size handle bar. The handle bar attachment 20 flexible material can be canvas, reinforced nylon fabric, Military Spec Laminated Fabric, Non-Flame Retardant Coated Fabric, Vinyl Coated Polyester Industrial Fabric, Gore-Tex, Drytex fabric or other commercially available fabric or flexible material. The handle bar attachment 20 has battery housing 65 and right LED strip 35 and left LED strip 30.

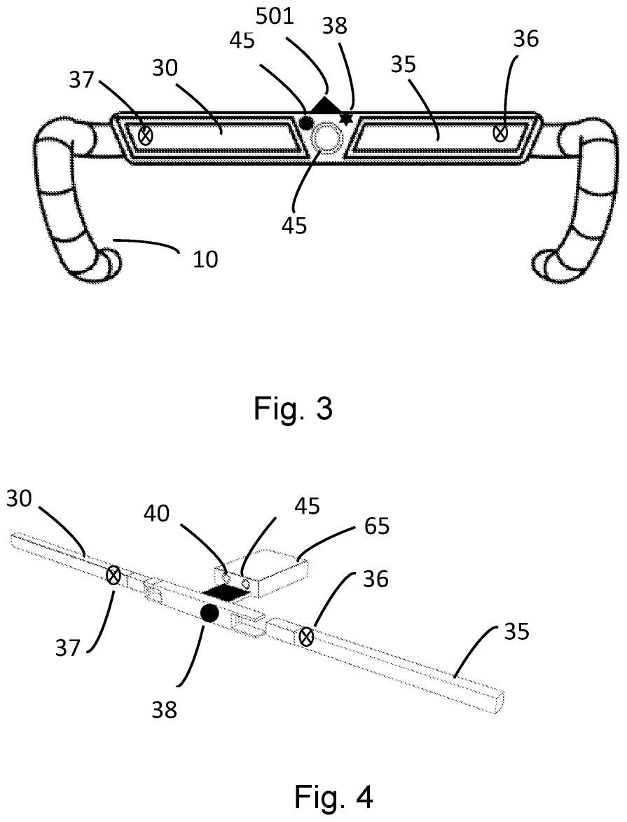

FIG. 3 shows detailed components of the safety device in a detachable version of the invention including camera 45, right LED strip 35, left LED strip 30, right sensor 36, left sensor 37, processor 501 and sensory alert device 38. However the instant invention envisions the possibility of using an incandescent light bulb or a single LED in place of the LED strip. The LED strip as envisioned by the instant invention is made of more than one LED.

FIG. 4 shows the instant invention with swappable sensor alert devices in a unified package including camera 45, integrated touch sensor 40, right LED strip 35, left LED strip 30, right sensor 36, left sensor 37, battery housing 65 and sensory alert device 38.

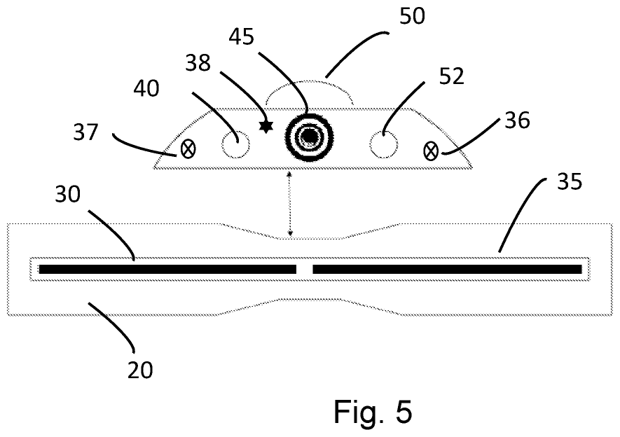

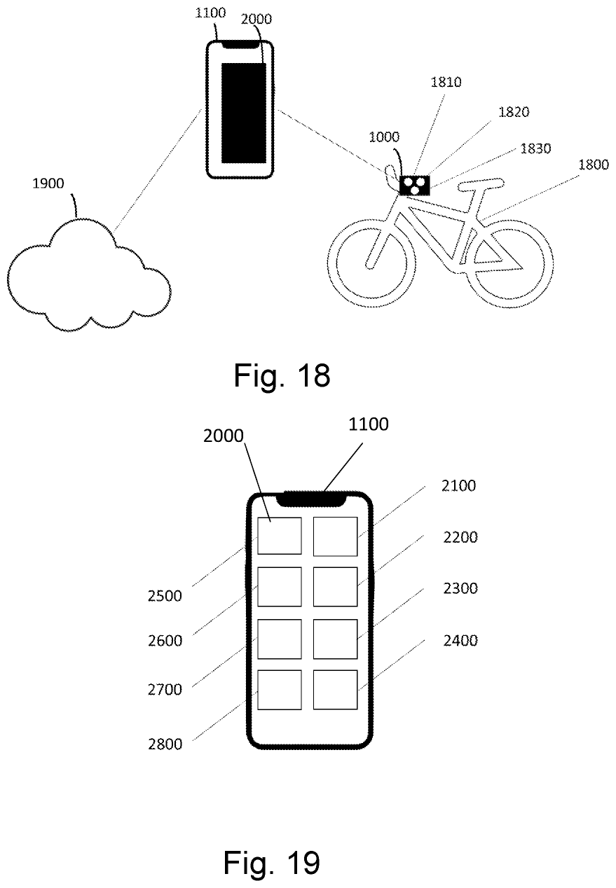

FIG. 5 shows the instant invention 20 with separate data hub 50 for capturing environmental data with camera 45, integrated touch sensor 40, right sensor 36, left sensor 37, inertial sensors 52, right LED strip 35, left LED strip 30, and sensory alert device 38. Alternatively the right LED strip 35, left LED strip 30 could be formed into one light strip if desired. Data hub 50 can also contain a processor 1830 which can be in wireless communication with the smart device or supervisory computer 1900 shown in FIG. 18.

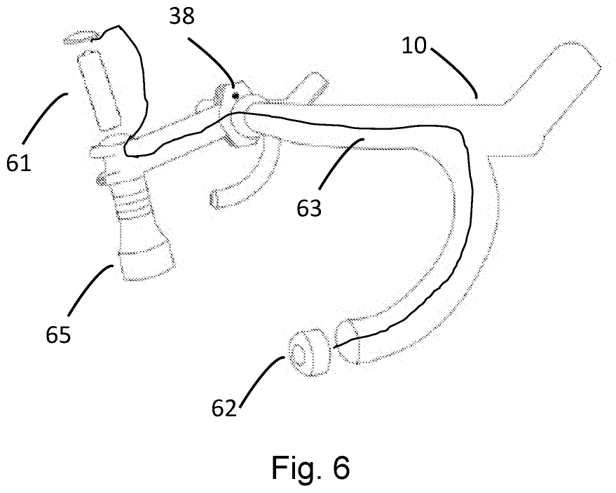

FIG. 6 shows the instant invention handlebar 10 and various components such as the integrated battery 61, on/off switch 62, and wiring 63 of the instant invention, and sensor alert device 38. The battery can be either a primary or secondary battery. The primary battery would be a single-use device such as an alkaline battery while secondary batteries is recharged such as a Li-ion battery,

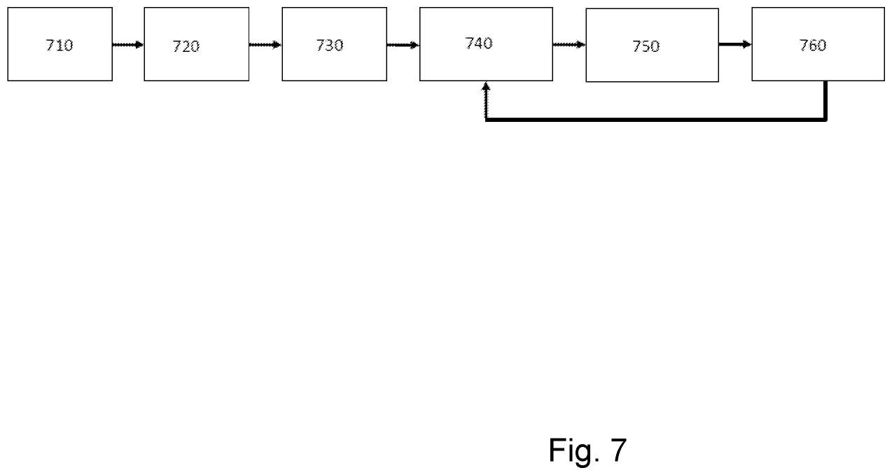

FIG. 7 shows a functional diagram of the instant invention to select the optimal sensory alert for raising awareness to nearby pedestrians of the users presence based on the sensor readings. The processor in either the mobile device or the integrated processor initializes step 710 then in step 720 the user selects the mode, the system then calibrates the sensors in step 730, the sensors read the environmental data step 740, the processor analyzes the route step 750 and then selects the optimum sensory alert step 760. The control is then past to step 740 and the system repeats until terminated by the on/off switch 62 in handlebar 10 as shown in FIG. 6.

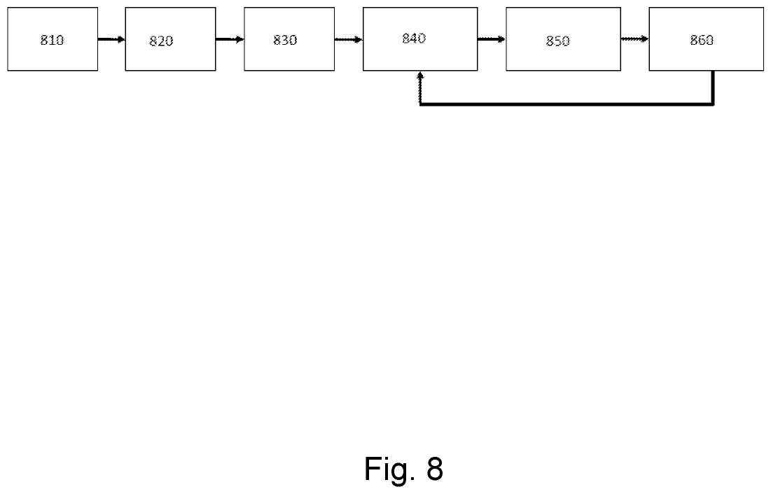

FIG. 8 shows a functional diagram of the instant invention to select the optimal sensory alert for raising awareness to nearby pedestrians of the users presence based on a wireless devices reading and communicating environmental data to the safety device. The processor in either the mobile device or the integrated processor initializes step 810 then in step 820 the user selects the mode, the system then synchronizes the wireless device step 830, the system then reads the environmental data from the smart device step 840 and the system then analyzes the route step 850 and then the system selects the optimal sensory alert step 860. The control is then past to step 840 and the system repeats until terminated by the on/off switch 62 in handlebar 10 as shown in FIG. 6.

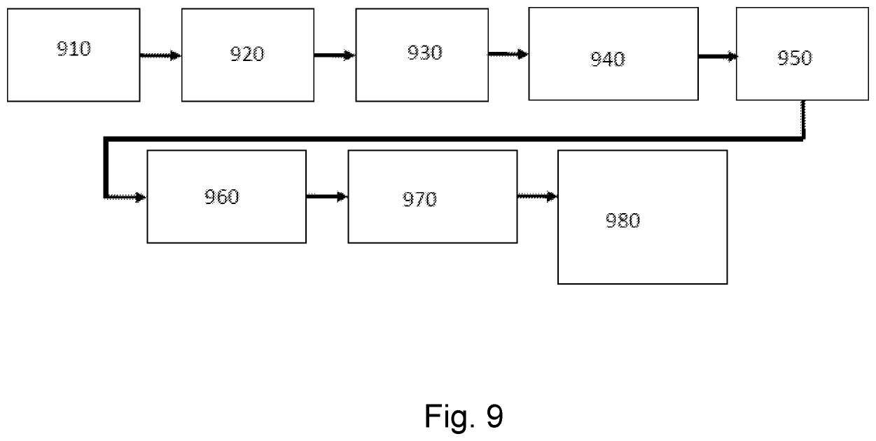

FIG. 9 shows a functional diagram of the system to award the traveler with promotions from 3rd party vendors that are along repeated traveled routes by the user to encourage use of the instant invention and create safer conditions. The processor in either the smart device/mobile device or the integrated processor initializes step 910 then in step 920 the system then synchronizes the wireless device, the system verifies the location using the GPS sensors step 930, the smart device reviews the stored route data to determine if the route has been traveled more than once step 940, the smart device then records the GPS data of the route step 950, the smart device then records the route GPS information step 960, the smart device can determine vendors on the route step 970 and the smart device can communicate promotions and earnings with vendors on the route step 980. The system repeats until terminated by the on/off switch 62 in handlebar 10 as shown in FIG. 6.

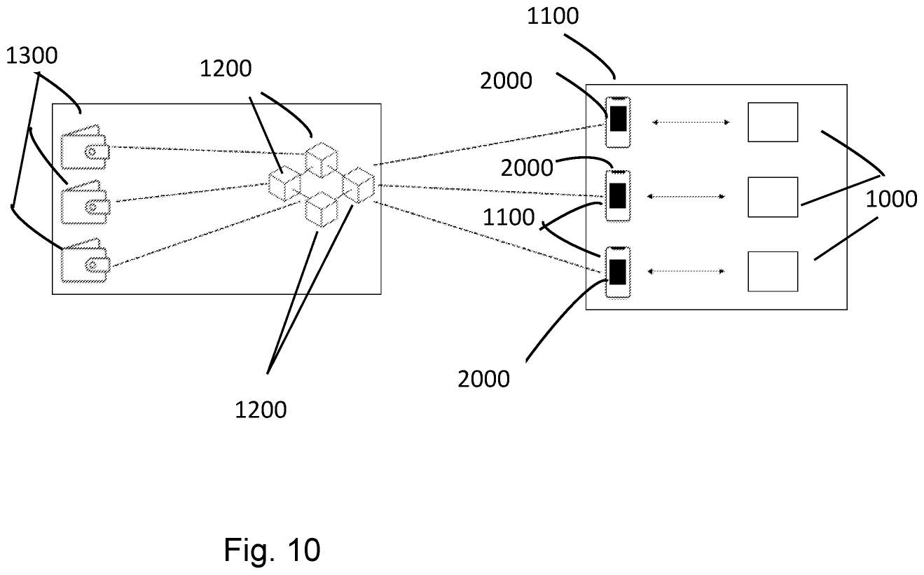

FIG. 10 shows a functional diagram of the system architecture to earn currency as the user utilizes the instant invention. In one embodiment, the safety device 1000 collects, processes and communicates user data, such as environmental data, GPS data, health statistics, mileage, incidents, traffic patterns, and time used to smart device 1100 through wireless technology such as Bluetooth, Wi/Fi, Zigbee, Ultrawideband, LTE, 4G and 5G Bluetooth, ultra-wide band and other wireless transmission methods. The instant invention envisions more than on smart device 1100 and software program 2000 using the instant invention. Smart device 1100 runs software program 2000 to process and communicate the information to the user via smart device's graphical user interface. Smart device 1100 also communicates all data acquired to processing system 1200 which can be a digital ledger technology, supervisory computer, data base, or cloud computing system. The instant invention envisions more than one processing system 1200 as part of the instant invention. The processing system 1200 wireless protocol can be selected from Bluetooth, Wi/Fi, Zigbee, Ultrawideband, LTE, 4G and 5G Processing system 1200 sorts, stores, and calculates earnings which is calculated from miles driven, time used, number of bytes of data and other pertinent metrics uploaded from safety device 1000 to smart device 1100. Processing system 1200 then disperses earnings or earned currency in local or foreign currency to the user's digital wallet, bank account, or payment processing service accounts 1300. The earn currency amount can be selected from the group consisting of cryptocurrency, dollars, pounds, Euro's, Yen or Yuan.

In another embodiment, smart device 1100 acquires data such as local environmental data, user health data, traffic patterns, and also receives usage data from safety device 1000. Smart device 1100 communicates acquired data via wireless transmission technology to safety device 1000 and also communicates commands to trigger the optimal sensory output of safety device 1000 to create greater awareness to surrounding pedestrians and motorists of the presence of the user of safety device 1000.

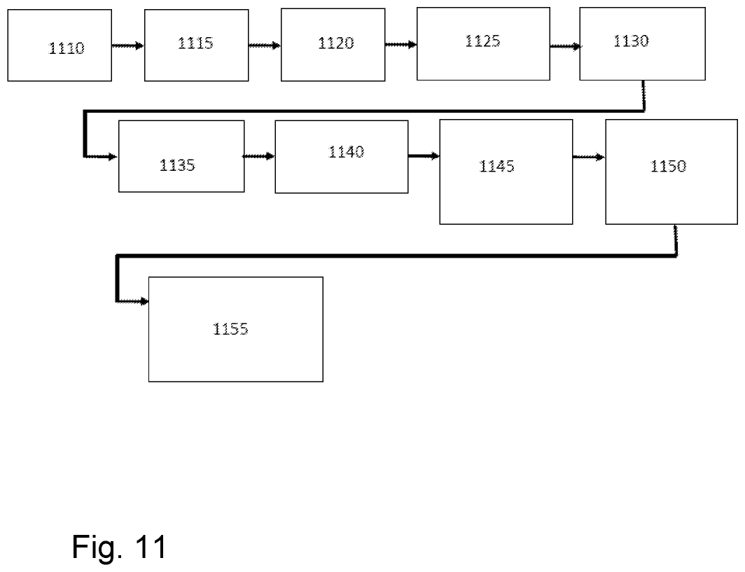

FIG. 11 shows a functional diagram of the verification process to ensure the user has used the instant invention in order to gain earnings from a local, cryptocurrency or virtual currency. The processor in either the smart device or mobile device or the integrated processor of the instant invention initializes step 1110 then in step 1115 the system then synchronizes the wireless device. The system verifies the location using the GPS sensors step 1120, the smart device receives and inputs a final destination by the user step 1125, and communicates the route options to the user step 1130. The route selection inputted by the user on the smart device step 1135, is recorded on the smart device and then via a wireless network on a data base, distributed ledger technology, or cloud computing system step 1140. Metrics in step 1140 about the route, such as GPS starting point, GPS end point, number count the route has been traveled, health statistics about the user while traveling the route, estimated time of arrival, weather along the route, or incidents along the route. Data submitted and stored step 1140 is then evaluated for metrics to calculate and disperse currency to the user step 1145. The evaluation of currency earned communicated to the user step 1150 can calculate a ratio on the amount of data submitted by bytes, the type of data submitted such as health statistics or data relating to user route preference, or time the instant invention is used. Once the calculation is performed step 1145 and communicated to the user step 1150, then the currency will be transferred to a virtual wallet step 1155. The system repeats until terminated by the on/off switch 62 in handlebar 10 of FIG. 6.

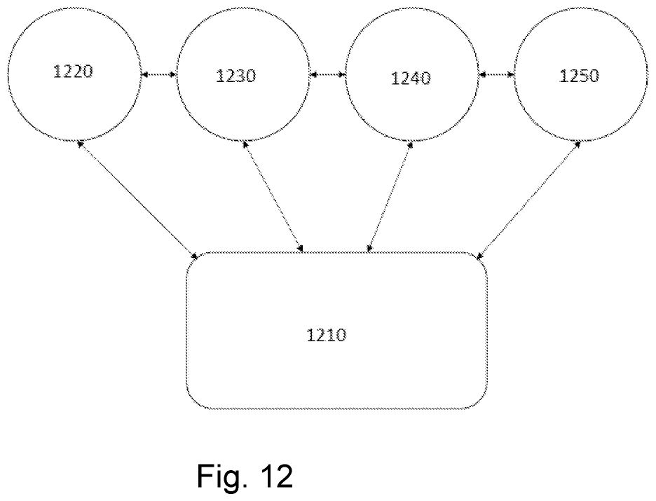

FIG. 12 shows a functional diagram of the instant invention able to communicate with other instant invention devices on a network, and exchange data from a central server to the instant invention. Safety device 1220, safety device 1230, safety device 1240, and safety device 1250 able to communicate data with each other via wireless transmission means such as over a Bluetooth, Wi/Fi, Zigbee, Ultrawideband, LTE, 4G, 5G and NFC and other long and short range wireless technologies and collected and processed by 1210, a data base, distributed ledger technology, or cloud storage. Data communicated between safety device 1220, safety device 1230, safety device 1240, and safety device 1250 communicated to the user by smart device 1100 of FIG. 10. Data such as but not limited to incident reporting, traffic patterns, weather, temperature, obstructions, or emergency alerts are examples.

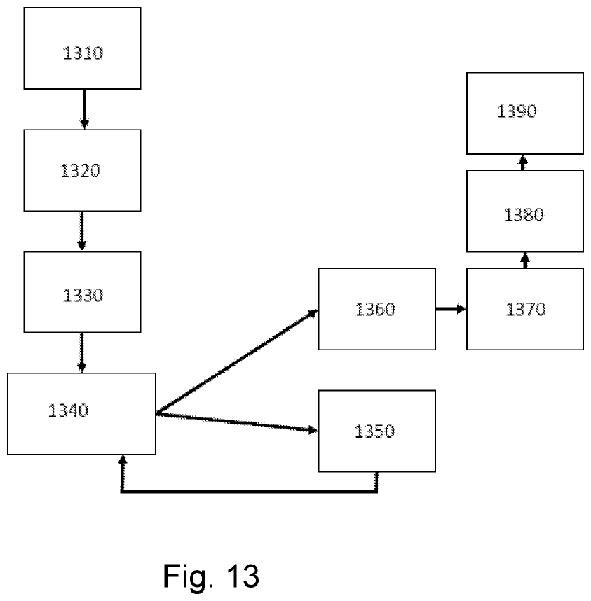

FIG. 13 is a functional diagram of the instant invention to detect accidents and change sensory triggers to surrounding pedestrians and alert the emergency contacts of the user. The processor in either the smart device or mobile device or the integrated processor of the instant invention initializes step 1310 then in step 1320 the system then synchronizes the wireless device to the safety device. The system verifies the location using the GPS sensors step 1330. Using the safety device 10 of FIG. 3, or smart device sensors 1100 of FIG. 10 such as an accelerometer or vibration sensor, the instant invention prompts the system to see if there was a harmful incident to the user of the instant invention step 1340. The sensors at step 1340 will produce readings indicative of an incident such as a hit and run accident 1360 or no detected incident 1350 which is determined by the sensor readings of safety device 10 of FIG. 3. Left sensory alert device 30, or right sensory alert device 35 of FIG. 3, are switched to an SOS mode to alert oncoming passers of the accident and prevent another incident such as a collision. SOS sensory alerts may be in the form of red flashing LED lights with differing pulse width modulation, or alarms with audible alerts communicated to surrounding persons of the user by sensor alert device 30 or right sensory alert device 35. The incident is recorded first on smart device 1100 and then on supervisory computer, wireless data base, cloud storage, or distributed ledger 1900 (shown in FIG. 18) to allow communication of the incident to an emergency contact of the user step 1380, via SMS messaging, text messaging, phone calls, or other messaging services. The incident is reported to other nearby users utilizing the instant invention step 1390, via graphical user interface 2000 (shown in FIG. 108) run on smart device or computer 1100. The supervisory computer, wireless data base, cloud storage, or distributed ledger 1900 wireless communication protocol which allows the supervisory computer, wireless data base, cloud storage, or distributed ledger 1900 to wirelessly communicate with the smart device 1100 and or the processor 1830 and the wireless protocol can be selected from the group comprising of Bluetooth, Wi/Fi, Zigbee, Ultrawideband, LTE, 4G, 5G and NFC.

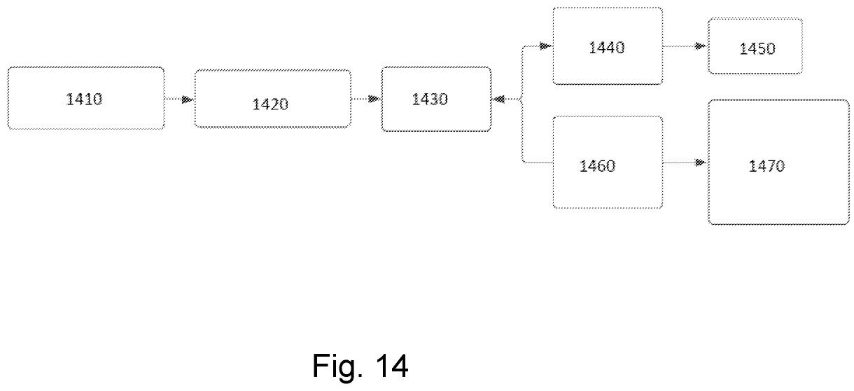

A functional diagram is shown in FIG. 14 is a functional diagram of the instant invention to detect incidents of accidents and also incorporate a kill switch to deactivate any sensory alerts from be sent to emergency contacts. The instant invention accelerometer senses high speed impact above normal levels step 1410, the instant invention activates local on board alarm step 1420 the alarm is activated step 1430, if the user is able to or desires to they can press a kill switch to stop the alarm step 1440 and the alarm will be deactivated step 1450, if the user is unresponsive the instant invention will alert local emergency services step 1460 and step 1470 the instant invention sends location coordinates to emergency services.

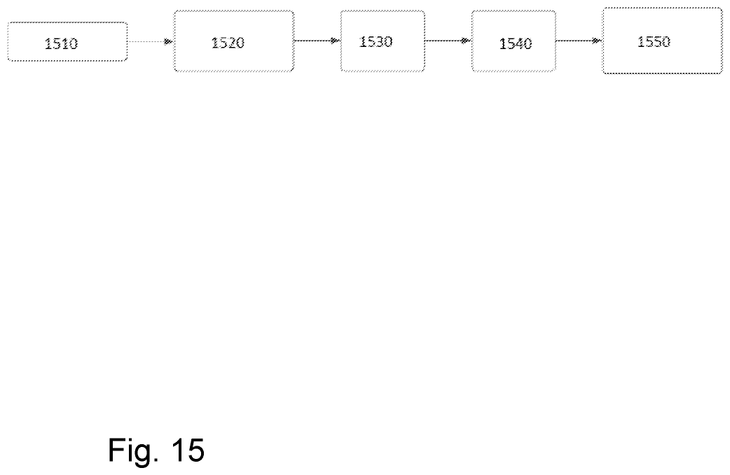

FIG. 15 is a functional diagram of the instant invention to detect user controls from conformal switches built into the instant invention where the user places his or her hands on the handlebars of a bicycle, motorcycle, scooter, ATV, or stroller where the instant invention is attached or integrated into and initiates the system through passive touch mode sensors to detect the presence of the user's hands on the handlebar step 1510. The sensors or switches comprised of momentary switches, mechanical on/off switches, touch mode switches, metal touch mode nodes of an open loop circuit. In step 1520 switches the safety device to the ON mode. The instant invention remains active step 1530 as long as the user's left or right hand remains on the handlebar and activates the switch to close an electronic circuit of the instant invention. Once the user removes both the left hand and the right hand step 1540 the instant invention turns off and goes into a sleep or standby mode 1550.

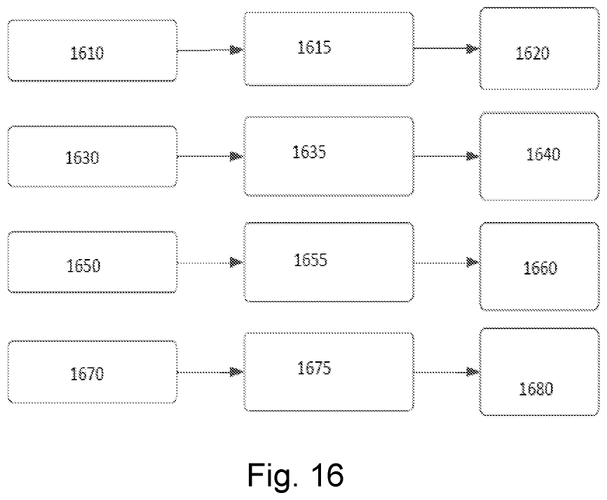

FIG. 16 is a functional diagram of the instant invention to manually control differing sensory alerts of the instant invention as a result of differing rider actions. The user can select a control step with the left or right hand of the user 1610 to compress a switch or activate a sensor step 1615 to increase brightness of the instant invention step 1620. The user can select a control with the left or right hand of the user step 1630 to compress a switch or activate a sensor step 1635 to decrease brightness of the instant invention step 1640. The user of the instant invention may apply pressure to the brake handles of a two or four wheeled vehicle step 1650 which engages a switch step 1655 and causes a sensory alert to turn on the front or back of the instant invention step 1660. The instant invention can also enable the user such that when they release pressure to the brake handles of a two or four wheeled vehicle step 1670 which disengages an electronic or mechanical switch step 1675 and turns off the sensory alert 1680.

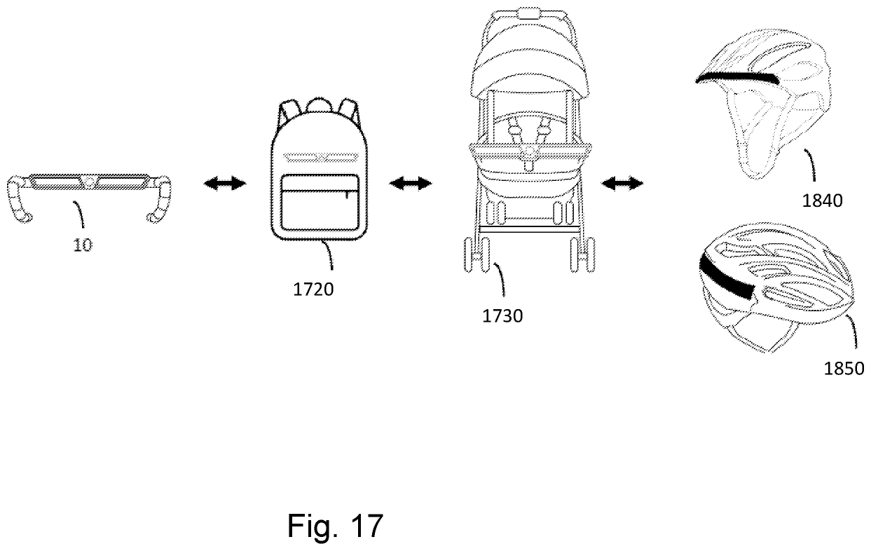

FIG. 17 is a diagram of the instant invention to be adapted from differing use cases. The instant invention is integrated with adjustable mounts to allow adaptive mounting between a handlebar 10, backpack 1720, stroller 1730, front face of a protective helmet 1740, or rear face of a protective helmet 1750. The adjustable mounts made from two magnetic parts with opposing poles, straps, zip ties, beaded ties, Velcro or other mounting technologies.

FIG. 18 is a diagram of the instant invention where safety device 1000 is mounted to two wheeled vehicle 1800 with sensor 1810, wireless communication technology 1820, processor 1830, processor 1830 can be a microprocessor. Sensor 1810 comprised of a pressure sensor, barometer, anemometer, accelerometer, gyroscope, or other sensor technology reads data from the local environment of the user or information about the user such as health statistics, fatigue, calories burned, distance driven or distance walked, and processed by processor 1830 to translate the data in a format that can be accepted by smart device 1100. Processor 1830 comprising of a processor, microprocessor, or application specific integrated circuit to accept raw data from sensor 1810 and process the data. Wireless communication technology 1820 comprising of a processor 1830 wireless transmission protocol which is selected from the group consisting of Bluetooth, Wi/Fi, Zigbee, Near Field Communications (NFC), LTE, 4G and 5G. Zigbee, Ultrawideband, or other wireless communication technologies accepts the data from processor 1830 and communicates the data to smart device 1100 which can be viewed by the user on graphical user interface 2000 which is run on smart device 1100. Smart device 1100 then transfers the data to wireless storage system 1900 comprising of a supervisory computer, remote server, data base, cloud, or distributed ledger technology. Wireless storage system 1200 able to transfer data such as weather, incident reports, or user inputs to other smart devices 1100 that have access to wireless storage system 1200. In another embodiment it should be appreciated that the functions described in FIG. 16 may also be read by sensor 1810 as shown in FIG. 18, which is then processed by processor 1830 to control inputs and outputs of safety device 1000. It should also be appreciated that smart device 1100 comprises a graphical user interface which can receive inputs to control the inputs or outputs of safety device 1000 and communicates each input or output via wireless communication technology 1820.

FIG. 19 is a diagram of graphical user interface 2000 which is run on smart device 1100 and communicates information to the users of the instant invention. Graphical user interface comprising of several different modules. Module 2100 able to communicate health statistics about the user acquired from sensor 1810 as shown in FIG. 18. Module 2100 able to communicate data such as but not limited to blood pressure, calories burned, blood oxygen saturation, temperature, heart rate, work performed, and other future health statistics. Module 2200 able to portray environmental statics such as but not limited to weather, road conditions, pressure, precipitation statistics, or elevation. Module 2300 able to communicate incidents detected by safety device 1000 or reported by 3^{rd} party vendors. Incidents communicated comprising of road accidents between cars, road accidents between cyclists, or incidents that may be of danger to the user. Module 2400 able to communicate information about the user's route of travel comprising of distance, topography of the route such as hills or down hills, traffic light data, traffic patterns, or traffic flow. Module 2500 able to communicate promotions earned by local vendors based on the routes frequently traveled by the user. Module 2600 able to communicate information or alerts uploaded to the instant invention by other users or 3^{rd} party vendors. Module 2700 able to communicate currency earnings the user accumulates or spends. Module 2800 comprising of an artificial intelligence which learns and optimizes information displayed by other modules such as the route traveled by the user, pace of the user and energy spent, or time traveled by the user.

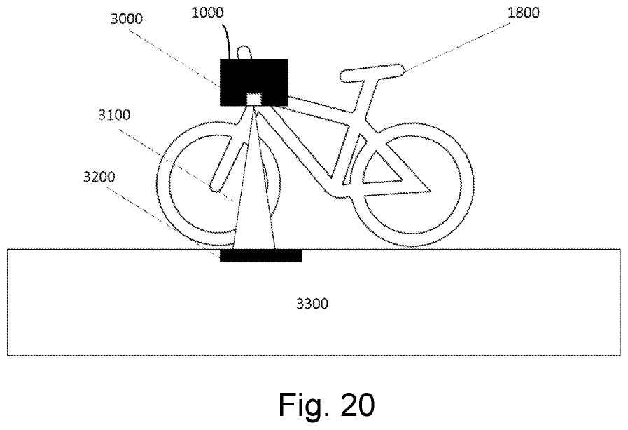

FIG. 20 is a diagram of the instant invention where safety device 1000 is mounted to bicycle 1800. Safety device 1000 built with projection device for a sensory alert 3000. When the instant invention detects such as from sensor 1810 from FIG. 19 a change in the environment, a projection 3100 is illuminated on the ground 3300 from projection unit 3000. The projection unit 3000 may be in the form of a laser, or LED light. Projection 3200 may change in its shape, form, color, or size to have the optimal setting for alerting surrounding pedestrians and motorists of the presence of the user.

The instant invention can be further envisioned as a safety device with sensors attached to a vehicle to detect changes in the environment and adapt sensory alerts of the unit to the surrounding pedestrians when a user is within a certain signaling and the safety device comprising:
a. an accelerometer that detects the motion or change in direction of the user;
b. a housing comprising containing a processor wirelessly in communication with a mobile device using a wireless protocol which can be selected from the group consisting of Bluetooth, Wi/Fi, Zigbee, Near Field Communications (NFC), Ultrawideband, LTE, 4G and 5G and the housing further comprising:
   i. a magnetic quick disconnect charging port;
   ii. an inductive charging base unit;
   iii. an integrated blinker;
   iv. a quick release mount enabled to attach the safety device with sensors to a support device and the support device can be selected from the group consisting of a backpack, a scooter, a helmet, a handlebar and a belt;
   v. a swappable light fixture and battery attachment enabled to support different LED colors, brightness, blinkers, different battery capacity sizes and the swappable light fixture and battery attachment method can be selected from the group consisting of clips, straps, tie wraps, zip ties, hooks, clasps and Velcro
   vi. the integrated blinker is activated by the user activating a momentary switch on the integrated blinker.
   vii. the integrated blinker can be attached to the vehicle handlebars, brake handles or attached to support device and the support device can be selected from the group consisting of a backpack, a scooter, a helmet, a handlebar and a belt;
   viii. the processor enabled to wirelessly transmit performance statistics comprising of calories burned, heart rate, distance on using a heads up display which displays the transmit performance statistics on a local surface such as the ground or nearby wall using a laser or LED light;
   ix. the performance statistics inform the user of without having to strain to read a small display.

The vehicle can be a bicycle, a scooter, a tricycle, an all-terrain vehicle or two wheeled motor vehicle such as a motor cycle.

In an alternate embodiment the instant invention is a flexible handle bar attachment safety device for use with the handlebar of a bicycle comprising:
a. the flexible handle bar attachment made of a flexible material and attached to the handle bar with clips;
b. the flexible handle bar attachment having at least one sensor to detect changes in the environment;
c. the flexible handle bar attachment having an at least one alert device
d. the flexible handle bar attachment having at least one housing containing a processor enabled to wirelessly communicate using a processor wireless transmission protocol with a smart device and the smart device having a smart device application;
e. the smart device being wirelessly in communication with a supervisory computer with a supervisory computer application and the smart device having a smart device application on the smart device enabled to wirelessly transmits the GPS coordinates of the smart device to the supervisory computer with a supervisory computer application using a smart device wireless transmission protocol;
f. the supervisory computer application using the GPS coordinate wirelessly transmits the GPS coordinate using a wireless transmission protocol route information to the smart device;
g. the smart device capable of displaying the route information to the user using the smart device application;
h. the supervisory computer application using the GPS coordinate identifies vendors on route and wirelessly transmits using a wireless transmission protocol at least one vendor information to the smart device and the smart device using the smart device application displays the at least one vendor information to the user;
i. the flexible handle bar attachment having at least one battery housing;
j. the flexible handle bar attachment having at least one right LED strip;
k. the flexible handle bar attachment having at least one left LED strip;
l. the flexible handle bar attachment having at least one at least one alerting device;
m. the flexible handle bar attachment having at least one control button;
n. the flexible handle bar attachment wirelessly transmits using wireless transmission protocol a wireless route information to the smart device and the smart device transmits the route information to the supervisory computer and the supervisory computer application calculating earn currency amount based on the user use of the flexible handle bar attachment and the route information;
o. the supervisory computer and the supervisory computer application transmits the earn currency amount to the smart device and the smart device application displays the earn currency amount to the user.

The safety device for use with the handlebar of a bicycle of the instant invention wherein the flexible material is selected from the group consisting of canvas, reinforced nylon fabric, Military Spec Laminated Fabric, Non-Flame Retardant Coated Fabric, Vinyl Coated Polyester Industrial Fabric, Gore-Tex and Drytex fabric.

The safety device for use with the handlebar of a bicycle of the instant invention wherein the processor wireless transmission protocol is selected from the group consisting of Bluetooth, Wi/Fi, Zigbee, Near Field Communications (NFC), Ultrawideband, LTE, 4G and 5G.

The safety device for use with the handlebar of a bicycle of the instant invention wherein the smart device wireless transmission protocol is selected from the group consisting of Bluetooth, Wi/Fi, Zigbee, Ultrawideband, LTE, 4G and 5G.

The safety device for use with the handlebar of a bicycle of the instant invention wherein the supervisory computer wireless transmission protocol is selected from the group consisting of Bluetooth, Wi/Fi, Zigbee, Near Field Communications (NFC), Ultrawideband, LTE, 4G and 5G.

The safety device for use with the handlebar of a bicycle of the instant invention wherein the route information comprises of vendors on the route, coordinates of the route, time of travel information of the route and speed associated with the movement of the smart device using the route.

The safety device for use with the handlebar of a bicycle of the instant invention wherein the earn currency amount can be selected from the group consisting of cryptocurrency, dollars, pounds, Euro's, Yen and Yuan.

In some embodiments, the system, method or methods described above may be executed or carried out by a computing system including a tangible computer-readable storage medium, also described herein as a storage machine, that holds machine-readable instructions executable by a logic machine such as a processor or programmable control device to provide, implement, perform, and/or enact the above described methods, processes and/or tasks. When such methods and processes are implemented, the state of the storage machine may be changed to hold different data. The logic machine may execute machine-readable instructions via one or more physical information and/or logic processing devices. For example, the logic machine may be configured to execute instructions to perform tasks for a computer program. The logic machine may include one or more processors to execute the machine-readable instructions. The computing system may include a display subsystem to display a graphical user interface (GUI) or any visual element of the methods or processes described above. For example, the display subsystem, storage machine, and logic machine may be integrated such that the above method may be executed while visual elements of the disclosed system and/or method are displayed on a display for user consumption. The computing system may include an input subsystem that receives user input. The input subsystem may be configured to connect to and receive input from a variety of devices. For example, a user input may indicate a request that certain task is to be executed by the computing system, such as requesting the computing system to display any of the above described information, or requesting that the user input updates or modifies existing stored information for processing. A communication subsystem may allow the methods described above to be executed or provided over a computer network. For example, the communication subsystem may be configured to enable the computing system to communicate with a plurality of personal computing devices. The communication subsystem may include wired and/or wireless communication devices to facilitate networked communication. The described methods or processes may be executed, provided, or implemented for a user or one or more computing devices via a computer-program product such as via an application programming interface (API).

Since many modifications, variations, and changes in detail can be made to the described embodiments of the invention, it is intended that all matters in the foregoing description and shown in the accompanying drawings be interpreted as illustrative and not in a limiting sense. Furthermore, it is understood that any of the features presented in the embodiments may be integrated into any of the other embodiments unless explicitly stated otherwise. The scope of the invention should be determined by the appended claims and their legal equivalents.

In addition, the present invention has been described with reference to embodiments, it should be noted and understood that various modifications and variations can be crafted by those skilled in the art without departing from the scope and spirit of the invention. Accordingly, the foregoing disclosure should be interpreted as illustrative only and is not to be interpreted in a limiting sense. Further it is intended that any other embodiments of the present invention that result from any changes in application or method of use or operation, method of manufacture, shape, size, or materials which are not specified within the detailed written description or illustrations contained herein are considered within the scope of the present invention.

Insofar as the description above and the accompanying drawings disclose any additional subject matter that is not within the scope of the claims below, the inventions are not dedicated to the public and the right to file one or more applications to claim such additional inventions is reserved.

Although very narrow claims are presented herein, it should be recognized that the scope of this invention is much broader than presented by the claim. It is intended that broader claims will be submitted in an application that claims the benefit of priority from this application.

While this invention has been described with respect to at least one embodiment, the present invention can be further modified within the spirit and scope of this disclosure. This application is therefore intended to cover any variations, uses, or adaptations of the invention using its general principles. Further, this application is intended to cover such departures from the present disclosure as come within known or customary practice in the art to which this invention pertains and which fall within the limits of the appended claims.

What is claimed is:

1. A flexible handle bar attachment safety device for use with the handlebar of a bicycle comprising:
a. said flexible handle bar attachment made of a flexible material and attached to said handle bar with clips;
b. said flexible handle bar attachment having at least one sensor to detect changes in the environment;
c. said flexible handle bar attachment having an at least one alert device
d. said flexible handle bar attachment having at least one housing containing a processor enabled to wirelessly communicate using a processor wireless transmission protocol with a smart device and said smart device having a smart device application;
e. said smart device being wirelessly in communication with a supervisory computer with a supervisory computer application and said smart device having a smart device application on said smart device enabled to wirelessly transmits said GPS coordinates of said smart device to said supervisory computer with a supervisory computer application using a smart device wireless transmission protocol;
f. said supervisory computer application using said GPS coordinate wirelessly transmits said GPS coordinate using a wireless transmission protocol route information to said smart device;
g. said smart device capable of displaying said route information to said user using said smart device application;
h. said supervisory computer application using said GPS coordinate identifies vendors on route and wirelessly transmits using a wireless transmission protocol at least one vendor information to said smart device and said smart device using said smart device application displays said at least one vendor information to said user;
i. said flexible handle bar attachment having at least one battery housing;
j. said flexible handle bar attachment having at least one right LED strip;
k. said flexible handle bar attachment having at least one left LED strip;
l. said flexible handle bar attachment having at least one at least one alerting device;
m. said flexible handle bar attachment having at least one control button;
n. said flexible handle bar attachment wirelessly transmits using wireless transmission protocol a wireless route information to said smart device and said smart device transmits said route information to said supervisory computer and said supervisory computer application calculating earn currency amount based on said user use of said flexible handle bar attachment and said route information,
o. said supervisory computer and said supervisory computer application transmits said earn currency amount to said smart device and said smart device application displays said earn currency amount to said user.

2. The safety device for use with the handlebar of a bicycle of claim 1 wherein said flexible material is selected from the group consisting of canvas, reinforced nylon fabric, Military Spec Laminated Fabric, Non-Flame Retardant Coated Fabric, Vinyl Coated Polyester Industrial Fabric, Gore-Tex and Drytex fabric.

3. The safety device for use with the handlebar of a bicycle of claim 1 wherein said processor wireless transmission protocol is selected from the group consisting of Bluetooth, Wi/Fi, Zigbee, Near Field Communications (NFC), Ultrawideband, LTE, 4G and 5G.

4. The safety device for use with the handlebar of a bicycle of claim 1 wherein said smart device wireless transmission protocol is selected from the group consisting of Bluetooth, Wi/Fi, Zigbee, Ultrawideband, LTE, 4G and 5G.

5. The safety device for use with the handlebar of a bicycle of claim 1 wherein said supervisory computer wireless transmission protocol is selected from the group consisting of Bluetooth, Wi/Fi, Zigbee, Near Field Communications (NFC), Ultrawideband, LTE, 4G and 5G.

6. The safety device for use with the handlebar of a bicycle of claim 1 wherein said clips is selected from the group consisting of clips, straps, tie wraps, zip ties, hooks, clasps, Velcro

7. The safety device for use with the handlebar of a bicycle of claim 1 wherein said route information comprises of vendors on said route, coordinates of said route, time of travel information of said route and speed associated with the movement of said smart device using said route.

8. The safety device for use with the handlebar of a bicycle of claim 1 wherein said earn currency amount can be selected from the group consisting of cryptocurrency, dollars, pounds, Euro's, Yen and Yuan.

9. A safety device with sensors attached to a vehicle to detect changes in the environment and adapt sensory alerts of the unit to the surrounding pedestrians when a user is within a certain signaling and said safety device comprising:
a. an accelerometer that detects the motion or change in direction of the user;
b. a housing comprising containing a processor wirelessly in communication with a mobile device using a wireless protocol which can be selected from the group consisting of Bluetooth, Wi/Fi, Zigbee, Near Field Communications (NFC), Ultrawideband, LTE, 4G and 5G and said housing further comprising:
i. a magnetic quick disconnect charging port;
ii. an inductive charging base unit;
iii. an integrated blinker;
iv. a quick release mount enabled to attach said safety device with sensors to a support device and said support device can be selected from the group consisting of a backpack, a scooter, a helmet, a handlebar and a belt;
v. a swappable light fixture and battery attachment enabled to support different LED colors, brightness, blinkers, different battery capacity sizes and said swappable light fixture and battery attachment method can be selected from the group consisting of clips, straps, tie wraps, zip ties, hooks, clasps and Velcro
vi. said integrated blinker is activated by said user activating a momentary switch on said integrated blinker.
vii. said integrated blinker can be attached to said vehicle handlebars, brake handles or attached to support device and said support device can be selected from the group consisting of a backpack, a scooter, a helmet, a handlebar and a belt;
viii. said processor enabled to wirelessly transmit performance statistics comprising of calories burned, heart rate, distance on using a heads up display which displays said transmit performance statistics on a local surface such as the ground or nearby wall using a laser or LED light;
ix. said performance statistics inform the user of without having to strain to read a small display.
